(19) United States
(12) Patent Application Publication
(10) Pub. No.: US 2002/0143663 A1
(43) Pub. Date: Oct. 3, 2002

(54) Commerce system

(76) Inventors: Simon Walsh, Castleknock (IE); Ronan MacRuairi, Blackrock (IE); Catherine Grogan, Castleknock (IE)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 09/822,759

(22) Filed: Mar. 30, 2001

(51) Int. Cl. G06F 17/60

(52) U.S. Cl. 705/27

(57) ABSTRACT

A commerce system for computer-based trading is disclosed. The system allows a user to interact with one or more vendors' e-commerce servers. The system comprising a relay server, that is operative to transfer page requests from a user to a vendor's e-commerce server, and transfer page data from the vendor's e-commerce server to the user having applied transforms to data received form the vendor's e-commerce server. The relay server is also operative to process purchase requests generated by a user to relating to e-commerce transactions with the vendor's server. In particular embodiments, the relay server can maintain a virtual shopping basket that contains items selected for purchase from several vendors' sites and can implement payment for these items in a single payment process.

### FIELD OF THE INVENTION

This invention relates to a commerce system. In particular, it relates to a commerce system for enabling computer-based selling of goods and services, for example, over the Internet.

### BACKGROUND OF THE INVENTION

One source of consumer resistance to on-line retail shopping is the diversity of web sites that a shopper must typically visit when buying a range of goods. The user must first find the site that offers the item that they wish to buy, they must then learn to use that particular site owner's system, and they must then enter their personal information and payment details. When buying a range of items, the shopper may have to go through this process several times, which can be both confusing and time-consuming.

One approach that addresses this difficulty is to construct a single web site that offers goods and services from several providers. This provides a user with a unified interface and a single shopping basket and payment system. However, this is not attractive to a vendor that already has an operational web-based shopping system since this site would either have to be abandoned, with a possible loss of existing customers, or maintained in parallel, with a consequent increase in cost and inconvenience.

### SUMMARY OF THE INVENTION

An aim of this invention is to provide a commerce system that is convenient for both users and vendor.

From a first aspect, this invention provides a commerce system for computer-based trading from a vendor's server, the system comprising a relay server, in which the relay server is operative to transfer page requests from a user to the vendor's e-commerce server, transfer page data from the vendor's e-commerce server to the user, and to process purchase requests generated by a user to relating to commerce transactions with the vendor's server.

The relay server can therefore provide a gateway through which a user can view pages from the vendor's server and can also provide a system for handling a user's transaction requests.

Most usefully, there are several such vendor's servers in a system embodying the invention. In such cases, the relay server presents the user with a common interface for processing transaction requests generated by a user to initiate an e-commerce transaction with any one or more of the vendor's servers.

In advantageous embodiments of the invention, the user can initiate a transaction with the vendor's server and make payment for the transaction with the relay server. More advantageously, the user can perform transactions with a plurality of vendors' servers and make payment for the transactions with the relay server, most preferably, in one interaction with the relay server. This allows a user to make transactions with several vendors and then pay for the transactions in one operation.

For example, the relay server may implement a common virtual shopping basket that can contain items (be these goods, services or other items) originating from a plurality of vendors. For example, contents collected in a shopping basket of a vendor's e-commerce server can be transferred to the common virtual shopping basket for further processing (and, in particular, for payment).

In some embodiments of the invention, the contents are transferred upon indication by the user that the contents of the virtual shopping basket are complete. In an alternative arrangement, contents are added to the common shopping basket as they are selected from the vendor's web site.

Most advantageously, the relay server is operative to obtain payment details from a user and to forward payment details to one or more vendors from whom the user has opted to make a purchase. This allows the user to make payment to multiple vendors in what is perceived as a single operation. Moreover, this can also provides the user with a full and unified transaction and event history, even though the events and transaction occurred across multiple disparate remote sites.

From another aspect (that is optionally provided in combination with the first aspect of the invention), the invention provides a commerce system for computer-based trading from a vendor's server comprising a relay server, in which the relay server is operative:

to receive from a client requests for pages from a vendor's e-commerce server;

to forward such requests to the vendor's e-commerce server; to receive page data from the vendor's e-commerce server;

to transform the page data; and

to return the transformed page data to the client; wherein the relay server applies transforms to the page such that e-commerce transactions performed by the user in relation to the vendor's e-commerce server are handled by the relay server.

Typically, in such a commerce system the transforms serve to redirect references to the vendor's web site to the relay server. For example, the transforms may serve to redirect (e.g. HTTP) Post and Get instructions from the vendor's server to the relay server.

In particular, these references may be associated with an object in a page that is activated by a user to initiate an e-commerce action, for example, in a link or button activated by a user to initiate a payment process. The references may also be contained within a script language function.

In a commerce system embodying this aspect of the invention, the transformed page data returned to the client may include a frames page, the source for one frame of which is derived from page data received from the vendor's server. Advantageously, a second frame of the frames page is displayed as a toolbar for performing e-commerce functions on the relay server. This can provide a common and consistent interface that a user can use to initiate e-commerce functions such as reviewing the content of a common shopping basket and paying for selected items.

This invention also provides, from a third aspect, a relay server for use in a system according to the first or second aspect of the invention.

From a fourth aspect, the invention provides computer software executable on computer hardware to perform the function of a relay server in the first or second aspect of the invention.

In this invention, the relay server acts as an intermediate between the end users (in typical embodiments, shoppers) and various web or WAP sites that are selling products and services. When an end user attempts to view one of the web sites handled by the relay server, the relay server interprets the request, requests the page from the web site, modifies the page as required and then supplies the modified page to the end user.

In most typical embodiments, the relay server communicates with the client and with vendors' servers using hypertext transfer protocol (HTTP) and the page data is encoded in hypertext mark-up language (HTML). Alternatively or additionally the relay server may communicate with the client and with vendors' servers using wireless application protocol (WAP), in which case the page data is typically encoded in wireless mark-up language (WML).

### BRIEF DESCRIPTION OF THE DRAWINGS

An embodiment of the invention will now be described in detail, by way of example, and with reference to the accompanying drawings, in which:

FIG. 1 is a block diagram of the principal components of a system embodying the invention;

FIG. 2 illustrates data flow within a system embodying the invention;

FIG. 3 illustrates diagrammatically a page in a vendor's web site; and

FIG. 4 illustrates diagrammatically the page of FIG. 3 as presented in a system embodying the invention.

### DESCRIPTION OF THE PREFERRED EMBODIMENTS

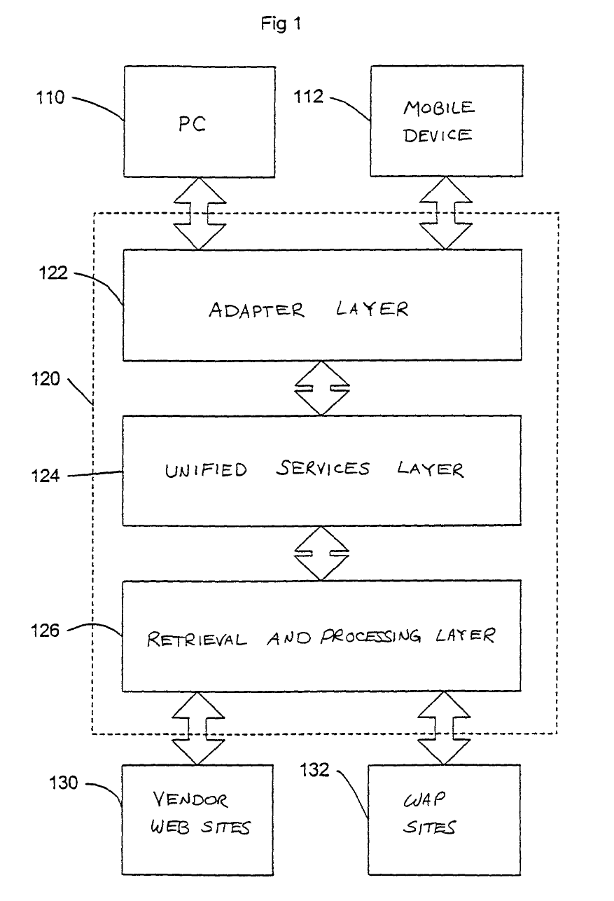

With reference to FIG. 1, a system embodying the invention includes one or more end-user devices. These might most typically include a personal computer 110 that is equipped with browser software and that can connect to the Internet. Additionally, users may access the system using other devices such as mobile cellular devices 112 that are compatible with the wireless application protocol (WAP) or another suitable protocol.

The user devices communicate with a relay server 120. The relay server 120 includes an adapter layer 122, a unified services layer 124 and a retrieval and processing layer 126. The operation of these will be described below. The relay server allows the user to communicate with a plurality of vendors' web sites 130 or WAP sites 132. Most typically, the vendor sites will be retail sites offering goods or services to consumers. However, they may alternatively be other e-commerce sites, for example, operating as wholesale sites or providing other business-to-business commerce facilities.

The user devices 110, 112 communicate bi-directionally with the adapter layer 122, using the protocol appropriate to the device. As new types of user device are developed, their protocol can be added to the adapter layer 122 to provide compatibility with them. The adapter layer 122 acts as a conversion layer between the device protocol and an internal protocol that is common to all requests handled by the system.

All communication to and from the adapter layer is passed through a unified services layer 124. The unified services layer 124 provides e-commerce and other services, and its functionality will be described in detail below.

The unified services layer 124 communicates with the various e-commerce sites 130, 132 through the site retrieval and processing layer 126. The site retrieval and processing layer 126 operates by generating requests in an appropriate protocol (for example, by generating a URL) and issuing a request for data to a vendor's web site. The site retrieval and processing layer 126 receives data returned by the sites and passing that data on to the common services layer. It will be noted that the site retrieval and processing layer 126 must interpret requests for pages that originate from a transformed page (to be described below) and generate an actual URL in the vendor's site that can be used to request page data.

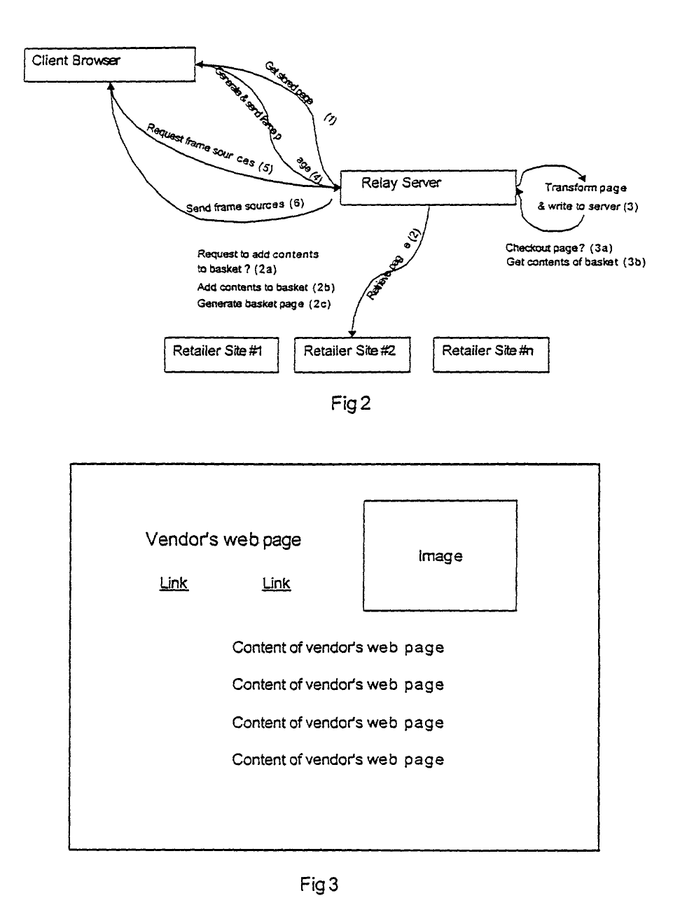

Flow of requests and returned data within the system will now be described, and is illustrated in FIG. 2. In the following description, the references in square brackets relate to the data flow lines in this figure.

A user contacts the system by directing their device to a home page of the service, which will cause the device 110 to contact the relay server 120. The home page includes links associated with a number of vendors' e-commerce servers 130, 132, each of which can be accessed by the user. Each link comprises a URL on the relay server plus an identification parameter that identifies the particular vendor's e-commerce server.

In the case when a user device is web-based, when a user clicks on the link for a store, an HTTP request (that might be an HTTP Get or an HTTP Post request) is directed to the relay server 120 [1]. The adapter layer 122 responds to this request by interpreting the identification parameter to generate a request to the vendor's e-commerce web site 130 in question through the site retrieval and processing layer 126. The request generated by the site retrieval and processing layer 126 mimics a request what might typically be generated by a user's web browser to request a page from the site.

An HTTP response, which will define a web page, is then awaited from the vendor's web site 130 [2]. The response is received by the site retrieval and processing layer 126 and is passed onto the unified services layer 124. The unified services layer 124 parses the response, breaking down the HTML code into components, and then applies transforms to the code [3], as will be described.

A first set of transformations is required to provide the user device with the correct information for display and logic purposes. In the case of a page encoded in HTML and these transformations include correcting URL paths which refer to page components (for example, images associated with page components such as hyperlinks) are correctly referenced within the domain of the relay server. Moreover, URLs in page that refer to hyperlinks are also transformed to ensure that, upon activation, the links are referenced through the relay server 120, rather than direct to the vendor's site. In addition, the transform searches for any component in the page that could result in either result in a HTTPGet, for example, an “<A HREF . . . >” tag or a HTTPPost, for example, a “FORM” tag.

For example: HTTP Post (Form)—Original

<form name=“logon” action=“shoplvalidate.asp” method=“post”>

HTTP Post (Form)—Transformed

<form name=“iogon”

action=“system.whtm?shopeAction=srps&userid=1476&token=143d77b877f735ce0edbbbba7fb67f32&shopeOptionat=none&withinStoreSessionld=none&shopeUrl=http://www.butierschocolates.com/shop/validate.asp” method=“post”>

HTTP Get (a Href)—Original

<a href=“index.asp”>

HTTP Get (a Href)—Transformed

<a

href=“system.whtm?shopeAction=srps&userid=1476&token=143d77b877f735ce0edbbbba7fb67f32&shopeOptional=none&withinStoreSessionld=none&shopeUrl=hftp://www.butlerschocolates.com/index.asp”>

These tags are transformed to re-direct the links to the relay server 120 by replacing the original link with a link to the relay server, adding a session ID which is maintained for the user and then including the original link as a parameter. (As an alternative to a session ID, cookies can be used to provide persistence.)

If required, special rules can be applied to transforming referenced, for example to replace references to a graphical element on a vendor's site with art work that is provided by the relay server.

Script (for example, JavaScript, ECMAScrpit or VBScript) tags are not transformed. However, if a script function includes a HREF or FORM tag, this is detected and transformed accordingly, as follows:

JavaScript Function Original

function basket_add(productid){window.open(“ . . . /shop/cart-add.asp”+“?productid=”+productid, productid,“width=298,height=180”);}

JavaScript Function Transformed

function

basket_add(productid){window.open(“system.whtm?shopeAction=srps&userid=1476&token=143d77b877f735ce0edbbbba7t67f32&shopeOptional=none&withinStoreSessionld=none&shopeUrl=”+escape(“http://www.butlerschocolates.com/shop/ . . . /shop/cart-add.asp”+“?productid=”+productid),

productid,“width=298,height=180”);}

To provide a specific example of how these transformations can be applied, Listing 1 resents the HTML source of a complete page from a vendor's web site before transformation, and Listing 2 presents the same page after the transformations have been made.

In this example, for each page requested by the browser, the relay server generates and returns a frames page that contains a pair of frames: one for a generic shopping center toolbar (login, check basket, go to home page); and another for the page from the vendor's web site. The client browser detects each frame definition of the frame set and sets up browser windows accordingly. Each frame definition also includes a /SRC parameter pointing to the URL which is to be rendered within the frame window. The browser issues a HTTP request for each URL, and the returned HTML is rendered within the respective frame. It will be noted that the toolbar is independent of the content of the page and therefore provides a consistent functional interface to the user.

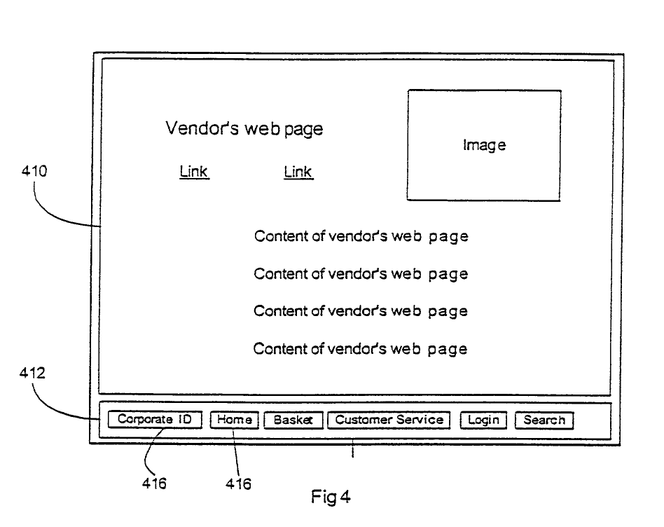

Thus, the page from the vendor's web site appears in the frame essentially as it would if the user were connected directly to the retailer site, unless its artwork is replaced. This is illustrated in FIGS. 3 and 4. FIG. 3 represents an image of a page downloaded direct from a vendor's web site. It contains an arbitrary collection of HTML components such as text, images and hyperlinks. When the same page is accessed through the relay server, the same content is displayed in a first frame 410 of a frames page [4]. A second frame 412 of the frames page contains content that is generated by the relay server. In this example, the second frame 412 contains a page that implements the generic toolbar that includes functional components, such as buttons 414 that a user can activate to perform functions relating to the payment and other e-commerce functions of the relay server, and other HTML components 416.

As is well-understood, when a user requests a page that is to be rendered as a set of frames, the web server first returns a frames page which is normally close to a standard format [4]. The client's browser detects each frame definition of the frame set and starts to render the page by setting up browser windows accordingly. Each frame definition includes a /SRC parameter pointing to the URL of the source that is to be rendered within the corresponding frame window. The browser issues an HTTP request for each URL [5] and the returned HTML is rendered within the respective frame [6].

The HTML code rendered in the first frame 410 is transformed as described above. If a user clicks on any of the links of this web page, this again causes a HTTP request to be sent to the relay server 120. The relay server 120 interprets the original URL parameter within the request and requests the original URL from the vendor's web site. When a response is again it is also transformed, and a framed window is sent to the client browser including one frame directed to the transformed page from the vendor's web site and another to page that defines the generic shopping center tool bar.

It will be seen that following the steps described above (references [1] to [6]) enable the relay server 120 to track the navigation of a shopping center user through a vendor's web site, with the exception of HTTP requests generated from within applets.

Optionally, further transformations may be applied by the site retrieval and processing layer 126 to a page contents in order to apply, for example, business-related alterations required by the operators of the relay server. This allows the contents of remote sites to be modified. For example, the transforms might implement price changes, site design and branding changes, adding links to a vendor's site to create a heterogeneous composite virtual web site, or to supply additional content, such as advertisements, etc.

In a first embodiment, the user freely navigates through the vendor's site. Having added one or more products to their shopping basket, the user then decides to check or view the contents of the shopping basket (for the vendor's site), for example, by clicking on a “shopping basket” icon within the web page from the vendor's site. For each vendor's site, the relay server 120 is programmed to detect a user's request for the shopping basket page. When the shopping basket page is returned from the vendor's site, as well as the normal transformation of the page, the shopping basket contents of the page are parsed and held by the relay server 120 ready to be written to a common shopping basket.

If such a request is received, [2a], the shopping basket contents detected as described above, are written to the common shopping basket [2b]. The relay server 120 then generates an HTML page representing the user's common shopping basket [2c] and returns this to the user essentially and skips step [4], as described above.

The vendor's shopping basket page usually also includes a “Checkout” button that a user will activate when all of their purchases have been selected. The functionality of this button is either replaced or a button is added to this page during transformation of the page by the relay server 120. The effect of this transformation is that, when pressed, a request is returned to the relay server 120, rather than to the vendor's server, requiring the contents of the vendor's shopping basket to be added to the common shopping basket maintained by the relay server 120. Examples of such a transform are shown below:

Checkout Button—Original

<a href=“register.asp”>

Checkout Button—Transformed

<a

href=“system.whtm?panel=basket_{—}0&shopeAction=basket&userid=1476&token=143d77b877f735ce0edbbbba7fb67f32”TARGET=‘ShopeContent’”>

A user can, at any time, choose to check the content of the common shopping basket and, optionally, complete the transaction. This can be done either by clicking a button within generic toolbar, or by navigating to a maintenance page generated by the relay server 120. The user is then requested to provide their payment details to the relay server 120 in a conventional manner. They may pay either by logging in to an account they have previously set up with the relay server 120 and to which their payment details are associated or by providing their payment details during each use of the services provided by the relay server. Whichever option is chosen, it will be seen that there is no need for the user to visit each vendor's site to pay as is the case with known systems.

Once payment instructions are received by the relay server 120, fulfilment instructions are provided to each vendor from whom the user has selected goods. This may be done in many ways, for example: by sending the vendor an e-mail message, by providing a customized module to interface with a vendor EDI system; by sending the order to a broker and having the vendor pick up their orders from the broker at a later time; or by implementing a module to mimic user interaction with a vendor web site when paying. In any case, it is the operator of the relay server 120 who is paid and reconciliation with each retailer must be performed with each retailer against orders to be fulfilled by the vendor.

It will be seen that if the checkout button on the vendor's site is not replaced by the translations described above, and a common shopping basket button is simply added to the retailer shopping basket page, then embodiments of the invention can be adapted to allow a user to check out a shopping basket on the vendor's site and so pay the vendor directly, rather than bringing the contents of the shopping basket back to the common shopping basket for central payment.

In a second embodiment, the relay server tracks a user adding items to the vendor shopping basket on vendor's site product pages and makes the corresponding additions to the common shopping basket. To achieve this, suitable transformations must be made to pages throughout the vendor's web site.

In a further alternative the vendor's web sight executes a software module that can provide information to the relay server. In particular, the software module can provide the relay server 120 with details of the contents of the shopping basket that the user has built up at the vendor's site.

It will be seen that while the embodiments have been described in terms of HTTP based web pages, adaptors can be used to transform non-HTTP retailer sites for use with both HTTP and non-HTTP clients, and new protocols can be readily accommodated.

Changes and modifications in the specifically described embodiments can be carried out without departing from the principles of the invention, which is intended to be limited only by the scope of the appended claims, as interpreted according to the principles of patent law.

[image]

[image]

[image]

[image]

[image]

[image]

[image]

[image]

[image]

[image]

[image]

[image]

[image]

[image]

[image]

[image]

1. A commerce system for computer-based trading from a vendor's server, the system comprising a relay server, in which the relay server is operative to transfer page requests from a user to the vendor's e-commerce server, transfer page data from the vendor's e-commerce server to the user, and to process purchase requests generated by a user to relating to e-commerce transactions with the vendor's server.

2. A commerce system according to claim 1 in which the relay server can communicate with a plurality of vendors' servers.

3. A commerce system according to claim 2 in which the relay server presents the user with a common interface for handling transaction requests generated by a user to perform an e-commerce transaction with any one or more of the vendor's servers.

4. A commerce system according to claim 3 in which the user can perform a transaction with the vendor's server and make payment for the transaction with the relay server.

5. A commerce system according to claim 4 in which the user can initiate transactions with a plurality of vendors' servers and make payment for the transactions with the relay server.

6. A commerce system according to claim 5 in which the user can make payment for transactions from a plurality of vendors' servers in one interaction with the relay server.

7. A commerce system according to claim 1 in which the relay server implements a common virtual shopping basket that can contain items originating from a plurality of vendors' servers.

8. A commerce system according to claim 7 in which the contents of a shopping basket of a vendor's e-commerce server can be transferred to the common virtual shopping basket for further processing.

9. A commerce system according to claim 8 in which contents of the contents are transferred upon indication by the user that the contents of the virtual shopping basket are complete.

10. A commerce system according to claim 7 in which contents are added to the common shopping basket as they are selected from the vendor's server.

11. A commerce system according to claim 1 in which the relay server is operative to obtain payment details from a user and to forward payment details to one or more vendors from whom the user has opted to make a purchase.

12. A commerce system according to claim 1 in which the relay server applies transforms to page data received from a vendor's server prior to transferring the page data to the user.

13. A commerce system for computer-based trading from a vendor's server comprising a relay server, in which the relay server is operative:
a. to receive from a client requests for pages from a vendor's e-commerce server;
b. to forward such requests to the vendor's e-commerce server;
c. to receive page data from the vendor's e-commerce server;
d. to transform the page data; and
e. to return the transformed page data to the client;
f. wherein the relay server applies transforms to the page such that e-commerce transactions performed by the user in relation to the vendor's e-commerce server are handled by the relay server.

14. A commerce system according to claim 13 in which the transforms serve to redirect references to the vendor's web site to the relay server.

15. A commerce system according to claim 14 in which the transforms serve to redirect Post and Get instructions from the vendor's server to the relay server.

16. A commerce system according to claim 14 in which the references are be associated with an object in a page that is activated by a user to initiate an e-commerce action.

17. A commerce system according to claim 14 in which the references are contained within a script language function.

18. A commerce system according to claim 16 in which the reference is associated with a link or button activated by a user to initiate a payment process.

19. A commerce system according to claim 13 in which the transformed page data returned to the client includes a frames page, the source for one frame of which is derived from page data received from the vendor's server.

20. A commerce system according to claim 19 in which the source for a second frame of the frames page is displayed as a toolbar for performing e-commerce functions on the relay server.

21. A commerce system according to claim 13 in which the relay server communicates with the client and with vendors' servers using hypertext transfer protocol (HTTP).

22. A commerce system according to claim 21 in which the page data is encoded in hypertext mark-up language (HTML).

23. A commerce system according to claim 13 in which the relay server communicates with the client and with vendors' servers using wireless application protocol (WAP).

24. A commerce system according to claim 23 in which the page data is encoded in wireless mark-up language (WML).
